(19) United States
(12) Patent Application Publication
(10) Pub. No.: US 2023/0314847 A1
(43) Pub. Date: Oct. 5, 2023

(54) PHASE MODULATION ELEMENT, PROJECTOR, AND HEAD-MOUNTED DISPLAY

(71) Applicant: SEIKO EPSON CORPORATION, Tokyo (JP)

(72) Inventor: Fumika YAMADA, Shiojiri-shi (JP)

(73) Assignee: SEIKO EPSON CORPORATION, Tokyo (JP)

(21) Appl. No.: 18/128,387

(22) Filed: Mar. 30, 2023

(30) Foreign Application Priority Data
Mar. 31, 2022 (JP) 2022-059008

(51) Int. Cl. G02F 1/01; G02B 27/01

(52) U.S. Cl. CPC G02F 1/0102; G02B 27/0172; G02B 2027/0178; G02F 2202/30

(57) ABSTRACT

A phase modulation element including a substrate and a plurality of first columnar portions constituting a first metasurface, in which each of the plurality of first columnar portions includes a first surface that is closest to the substrate, and a second surface that is farthest from the substrate, and an area of the second surface is smaller than an area of the first surface in plan view from a direction perpendicular to the substrate.

The present application is based on, and claims priority from JP Application Serial Number 2022-059008, filed Mar. 31, 2022, the disclosure of which is hereby incorporated by reference herein in its entirety.

### BACKGROUND

### 1. Technical Field

The present disclosure relates to a phase modulation element, a projector, and a head-mounted display.

### 2. Related Art

Since a metamaterial is composed of an artificial structure smaller than a wavelength of light, and magnetic permeability not found in nature can be obtained from a metamaterial, a metamaterial has a function, such as a negative refractive index, which is not found in optical materials in the related art. A metasurface in which such metamaterials are two dimensionally arranged is known.

For example, Published Japanese Translation No. 2019-516128 discloses a metalens that includes a substrate and a plurality of nanostructures disposed on the substrate and causes an optical phase shift that changes depending on the positions of the nanostructures. The nanostructures are made based on titanium dioxide.

In the metalens described above, it is desired to reduce light reflected by an interface of a nanostructure. When light is reflected by the interface of the nanostructure, a desired optical phase shift cannot be caused.

### SUMMARY

A phase modulation element according to an aspect of the present disclosure includes a substrate and a plurality of first columnar portions constituting a first metasurface, in which each of the plurality of first columnar portions includes a first surface that is closest to the substrate, and a second surface that is farthest from the substrate, and an area of the second surface is smaller than an area of the first surface in plan view from a direction perpendicular to the substrate.

A projector according to an aspect of the present disclosure includes an aspect of the phase modulation element.

A head-mounted display according to an aspect of the present disclosure includes an aspect of the phase modulation element.

### BRIEF DESCRIPTION OF THE DRAWINGS

FIG. 1 is a schematic cross-sectional view illustrating a phase modulation element according to a first embodiment.

FIG. 2 is a schematic cross-sectional view illustrating a manufacturing process of the phase modulation element according to the first embodiment.

FIG. 3 is a schematic cross-sectional view illustrating the phase modulation element according to the first embodiment.

FIG. 4 is a schematic cross-sectional view illustrating a phase modulation element according to a first modification example of the first embodiment.

FIG. 5 is a schematic cross-sectional view illustrating the phase modulation element according to the first modification example of the first embodiment.

FIG. 6 is a schematic cross-sectional view illustrating a phase modulation element according to a second modification example of the first embodiment.

FIG. 7 is a schematic cross-sectional view illustrating a phase modulation element according to a second embodiment.

FIG. 8 is a schematic cross-sectional view illustrating the phase modulation element according to the second embodiment.

FIG. 9 is a schematic cross-sectional view illustrating a phase modulation element according to a modification example of the second embodiment.

FIG. 10 is a schematic diagram illustrating a projector according to a third embodiment.

FIG. 11 is a schematic perspective view illustrating a head-mounted display according to a fourth embodiment.

FIG. 12 is a schematic diagram illustrating an image forming device and a light guiding device of the head-mounted display according to the fourth embodiment.

### DESCRIPTION OF EMBODIMENTS

Hereinafter, preferred embodiments of the present disclosure will be described in detail with reference to the accompanying drawings. Note that the embodiments to be described below are not intended to unjustly limit the content of the present disclosure as set forth in the claims. In addition, all configurations to be described below are not necessarily essential constituent requirements of the present disclosure.

### 1. First Embodiment

### 1.1. Phase Modulation Element

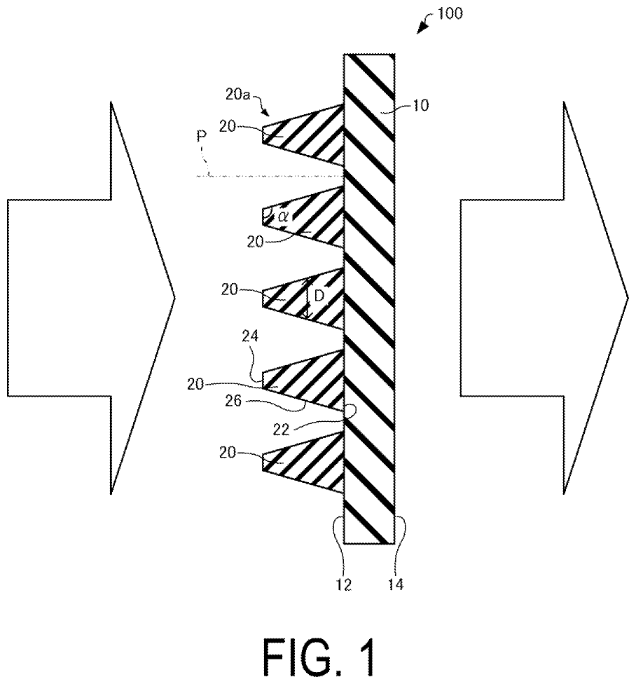

First, a phase modulation element according to a first embodiment will be described below with reference to the accompanying drawings. FIG. 1 is a schematic cross-sectional view illustrating a phase modulation element 100 according to a first embodiment.

As illustrated in FIG. 1, the phase modulation element 100 includes, for example, a substrate 10 and a plurality of first columnar portions 20.

The shape of the substrate 10 is, for example, a rectangular parallelepiped. The substrate 10 has, for example, a first main surface 12 and a second main surface 14. In the example illustrated in the drawing, the first main surface 12 and the second main surface 14 are parallel to each other. The substrate 10 transmits incident light. The refractive index of the substrate 10 is lower than the refractive index of the first columnar portion 20. The material of the substrate 10 is, for example, silicon oxide (SiO₂). The substrate 10 is, for example, a glass substrate.

The first columnar portion 20 is supported by the substrate 10. The first columnar portion 20 is provided on the first main surface 12 of the substrate 10. The first columnar portion 20 protrudes from the substrate 10 in the direction of a perpendicular P of the first main surface 12. The first columnar portion 20 is also referred to as, for example, a nanocolumn, a nanowire, a nanorod, or a nanopillar. In plan view seen from the direction of the perpendicular P, the shape of the first columnar portion 20 is, for example, a circle or a polygon such as a quadrangle. The direction of the perpendicular P is a perpendicular direction of the substrate 10.

The first columnar portion 20 has a first surface 22, a second surface 24, and a first side surface 26.

The first surface 22 of the first columnar portion 20 is a surface on the substrate 10 side. The first surface 22 is a surface of the first columnar portion 20 which is closest to the substrate 10. In the example illustrated in the drawing, the first surface 22 is in contact with the first main surface 12. The substrate 10 is provided on the first surface 22 side of the first columnar portion 20. In the example illustrated in the drawing, the first surface 22 is parallel to the second surface 24 and the first main surface 12.

The second surface 24 of the first columnar portion 20 is a surface on a side opposite to the first surface 22 of the first columnar portion 20. The second surface 24 is a surface of the first columnar portion 20 on a side opposite to the substrate 10. The second surface 24 is a surface of the first columnar portion 20 which is farthest from the substrate 10. The second surface 24 is a surface of the first columnar portion 20 on a side on which light is incident. Light incident from the second surface 24 side is emitted from the first surface 22 side. The area of the second surface 24 is smaller than the area of the first surface 22.

The first side surface 26 of the first columnar portion 20 connects the first surface 22 and the second surface 24. An angle α of the first side surface 26 with respect to the second surface 24 is, for example, greater than 90 degrees and equal to or less than 120 degrees. When the angle α is equal to or less than 120 degrees, the adjacent first columnar portions 20 can be separated from each other. In the example illustrated in the drawing, the first columnar portion 20 has a trapezoidal cross-sectional shape. The first columnar portion 20 has a tapered shape.

The height of the first columnar portion 20 is equal to or greater than 10 nm and equal to or less than 1 μm, preferably equal to or greater than 100 nm and equal to or less than 900 nm, and more preferably equal to or greater than 300 nm and equal to or less than 800 nm. The height of the first columnar portion 20 is, for example, greater than the diameter of the first columnar portion 20.

Note that “the height of the first columnar portion 20” is the size of the first columnar portion 20 in the direction of the perpendicular P. The same applies to a second columnar portion 30 to be described later.

In addition, a “diameter D of the first columnar portion 20” is a diameter when the shape of the first columnar portion 20 is a circle, and is a diameter of a minimum inclusion circle when the shape of the first columnar portion 20 is a shape other than a circle in plan view seen from the direction of the perpendicular P. For example, when the shape of the first columnar portion 20 is a polygon, the diameter D of the first columnar portion 20 is the diameter of the smallest circle including the polygon therein in plan view seen from the direction of the perpendicular P, and when the shape of the first columnar portion 20 is an ellipse, the diameter D of the first columnar portion 20 is the diameter of the smallest circle including the ellipse therein. The same applies to the second columnar portion 30 to be described later.

The diameter D on the second surface 24 of the first columnar portion 20 is equal to or greater than 10 nm and equal to or less than 1 μm, preferably equal to or greater than 100 nm and equal to or less than 800 nm, and more preferably equal to or greater than 200 nm and equal to or less than 700 nm. The diameter D of the first columnar portion 20 gradually increases toward the first surface 22 from the second surface 24.

A plurality of first columnar portions 20 are provided. The plurality of first columnar portions 20 are separated from each other. In the example illustrated in the drawing, a gap is provided between the adjacent first columnar portions 20. An interval between the adjacent first columnar portions 20 is equal to or greater than 10 nm and equal to or less than 1 μm, preferably equal to or greater than 100 nm and equal to or less than 800 nm, and more preferably equal to or greater than 200 nm and equal to or less than 700 nm. The plurality of first columnar portions 20 are arranged at a predetermined pitch in a predetermined direction in plan view seen from the direction of the perpendicular P. The plurality of first columnar portions 20 are arranged, for example, in a regular triangular lattice shape or a square lattice shape in plan view seen from the direction of the perpendicular P.

Note that “the pitch between the first columnar portions 20” is a distance between the centers of the first columnar portions 20 adjacent to each other in a predetermined direction. When the shape of the first columnar portion 20 is a circle, “the center of the first columnar portion 20” is the center of the circle in plan view seen from the direction of the perpendicular P, and when the shape of the first columnar portion 20 is a shape other than a circle, “the center of the first columnar portion 20” is the center of a minimum inclusion circle. For example, when the shape of the first columnar portion 20 is a polygon, the center of the first columnar portion 20 is the center of the smallest circle including the polygon therein in plan view seen from the direction of the perpendicular P, and when the shape of the first columnar portion 20 is an ellipse, the center of the first columnar portion 20 is the center of the smallest circle including the ellipse therein. The same applies to the second columnar portion 30 to be described later.

The first columnar portion 20 is made of a dielectric material. The material of the first columnar portion 20 is, for example, titanium oxide (TiO₂), silicon nitride (SiN), and gallium phosphide (GaP), or the like.

The first columnar portion 20 constitutes a metamaterial. The plurality of first columnar portions 20 constitute a first metasurface 20a. The first metasurface 20a transmits incident light. Light that passed through the first metasurface 20a passes through the substrate 10.

The first metasurface 20a in the phase modulation element 100 according to the present embodiment is a resonance type metasurface. Light incident on the first metasurface 20a is confined in the first metasurface 20a, resonates in a first waveguide mode in the direction of the perpendicular P, and resonates in a second waveguide mode in an in-plane direction orthogonal to the direction of the perpendicular P. In addition, light having a predetermined phase due to superimposition of the first waveguide mode and the second waveguide mode is emitted from the first metasurface 20a. The phase of the light emitted from the first metasurface 20a is appropriately determined by the diameter, height, and pitch of the first columnar portion 20.

Note that, although the first metasurface 20a in the phase modulation element 100 is a resonance type metasurface, the present disclosure is not limited thereto, and the first metasurface 20a may be a non-resonance type metasurface. When the first metasurface 20a is a non-resonance type metasurface, incident light propagates through the first metasurface 20a and is emitted with a phase corresponding to a propagation distance in the first columnar portion 20.

As described above, the first metasurface 20a can modulate the phase of incident light. The first metasurface 20a may have a function of a condensing lens, may have a function of a concave lens, may have a function of an off-axis lens in which a light condensing point is shifted, or may have a function of polarization.

Color light having one type of wavelength is incident on the first metasurface 20a, and the first metasurface 20a may modulate the phase of the color light having one type of wavelength. Alternatively, color light having a plurality of types of wavelengths may be incident on the first metasurface 20a, and the first metasurface 20a may modulate the phases of the color light having the plurality of types of wavelengths. When color light having a plurality of types of wavelengths is incident, the first metasurface 20a may have a function of correcting chromatic aberration.

### 1.2. Method of Manufacturing Phase Modulation Element

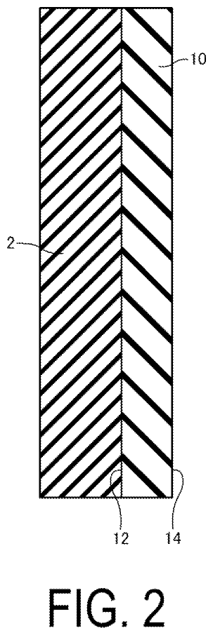

Next, a method of manufacturing the phase modulation element according to the first embodiment will be described with reference to the drawings. FIG. 2 is a schematic cross-sectional view illustrating a manufacturing process of the phase modulation element 100 according to the first embodiment.

As illustrated in FIG. 2, a dielectric layer 2 is formed on the substrate 10. The dielectric layer 2 is formed by, for example, a chemical vapor deposition (CVD) method or an atomic layer deposition (ALD) method.

As illustrated in FIG. 1, the dielectric layer 2 is patterned to form the plurality of first columnar portions 20. The patterning is performed by, for example, a nanoimprint method in which a mold having a predetermined pattern is pressed against the dielectric layer 2 to transfer the pattern to the dielectric layer 2. The nanoimprint method can pattern a large area at a time. Note that the patterning is not limited to the nanoimprint method. The patterning may be performed using, for example, a focused ion beam (FIB).

The phase modulation element 100 can be manufactured by the above-described process.

### 1.3. Operations and Effects

The phase modulation element 100 includes the substrate 10 and the plurality of first columnar portions 20 constituting the first metasurface 20a, each of the plurality of first columnar portions 20 includes the first surface 22 which is closest to the substrate 10 and the second surface 24 which is farthest from the substrate 10, and the area of the second surface 24 is smaller than the area of the first surface 22 in plan view seen from the direction of the perpendicular P.

For this reason, in the phase modulation element 100, an average refractive index in the in-plane direction in a portion of the phase modulation element 100 where the second surface 24 is provided can be made lower than that, for example, in a case where the area of the second surface is the same as the area of the first surface. Thereby, it is possible to reduce light reflected by the second surface 24 of the first columnar portion 20. Specifically, 0-order reflected light on the second surface 24, which is an interface between the first columnar portion 20 and air, can be reduced. As a result, light that is not phase-modulated by the first metasurface 20a can be reduced, and light use efficiency can be increased.

Furthermore, in the phase modulation element 100, since the area of the second surface 24 is smaller than the area of the first surface 22 in plan view seen from the direction of the perpendicular P, the mold used in the nanoimprint method can be easily released without deforming the shape of the columnar portion 20 when the dielectric layer 2 is patterned by a nanoimprint method.

In the phase modulation element 100, the diameter D of each of the plurality of first columnar portions 20 gradually increases toward the first surface 22 from the second surface 24. For this reason, in the phase modulation element 100, an average refractive index in the in-plane direction in a portion of the phase modulation element 100 where the first columnar portion 20 is provided can be gradually increased toward the first surface 22 from the second surface 24. Thereby, it is possible to reduce light reflected by the first side surface 26 of the first columnar portion 20.

In the phase modulation element 100, the refractive index of the substrate 10 is lower than the refractive index of each of the plurality of first columnar portions 20. For this reason, in the phase modulation element 100, an optical confinement factor of the first metasurface 20a can be increased as compared with a case where the refractive index of the substrate is higher than the refractive index of the first columnar portion.

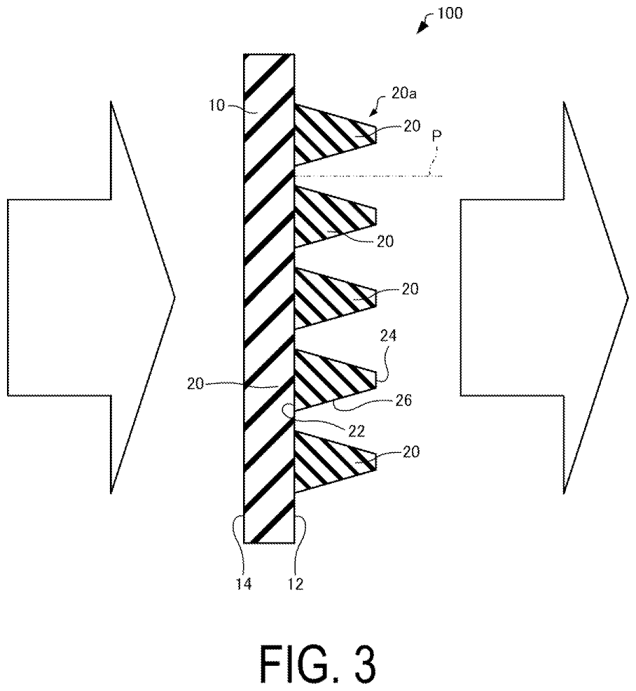

Note that, although an example in which light is incident from the second surface 24 side and emitted from the first surface 22 side has been described above, light may be incident from the first surface 22 side and emitted from the second surface 24 side as illustrated in FIG. 3. Even in such a case, the area of the second surface 24 is smaller than the area of the first surface 22 in plan view seen from the direction of the perpendicular P, and thus it is possible to reduce an average refractive index in the in-plane direction in the portion of the phase modulation element 100 where the second surface 24 is provided. Thereby, it is possible to reduce light reflected by the second surface 24 of the first columnar portion 20. In the example illustrated in the drawing, light is incident from the substrate 10.

### 1.4. Modification Example of Phase Modulation Element

### 1.4.1 First Modification Example

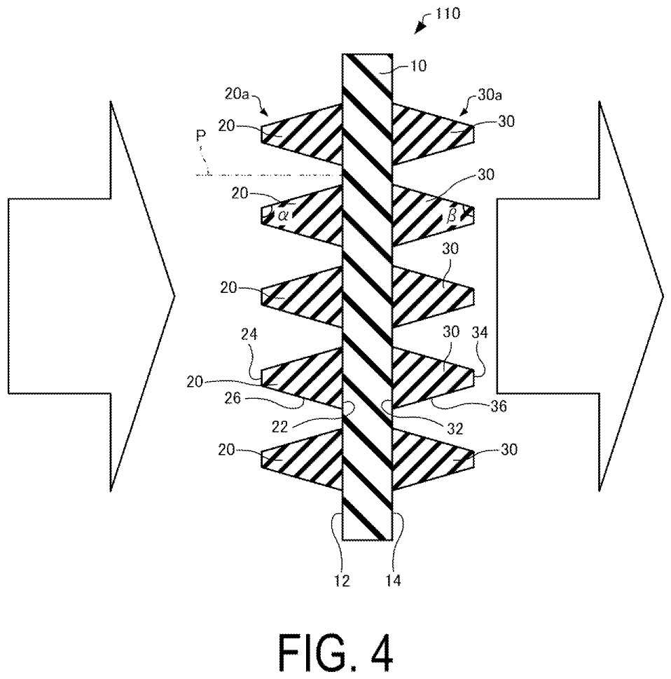

Next, a phase modulation element according to a first modification example of the first embodiment will be described with reference to the drawings. FIG. 4 is a schematic cross-sectional view illustrating the phase modulation element 110 according to the first modification example of the first embodiment.

Hereinafter, in the phase modulation element 110 according to the first modification example of the first embodiment, members having functions similar to those of the constituent members of the phase modulation element 100 according to the first embodiment described above are denoted by the same reference numerals and signs, and detailed description thereof is omitted. This is the same in a phase modulation element according to a second modification example of the first embodiment which will be described later.

As illustrated in FIG. 4, the phase modulation element 110 is different from the phase modulation element 100 described above in that a plurality of second columnar portions 30 are provided.

The plurality of second columnar portions 30 are provided on a side of the substrate 10 opposite to the plurality of first columnar portions 20. The plurality of second columnar portions 30 are provided on the second main surface 14 of the substrate 10. The second columnar portion 30 has a third surface 32, a fourth surface 34, and a second side surface 36.

The third surface 32 of the second columnar portion 30 is a surface on a side on which light that passed through the first metasurface 20a and the substrate 10 is incident. The third surface 32 is a surface of the second columnar portion 30 on the substrate 10 side. The third surface 32 is a surface of the second columnar portion 30 which is closest to the substrate 10. In the example illustrated in the drawing, the third surface 32 is parallel to the fourth surface 34 and the second main surface 14. The third surface 32 is in contact with the second main surface 14.

The fourth surface 34 of the second columnar portion 30 is a surface on a side opposite to the third surface 32 of the second columnar portion 30. The fourth surface 34 is a surface of the second columnar portion 30 on a side opposite to the substrate 10. The fourth surface 34 is a surface of the second columnar portion 30 which is farthest from the substrate 10. In plan view seen from the direction of the perpendicular P, the area of the fourth surface 34 is smaller than the area of the third surface 32. Light incident from the third surface 32 side is emitted from the fourth surface 34 side.

The second side surface 36 of the second columnar portion 30 connects the third surface 32 and the fourth surface 34. An angle β of the second side surface 36 with respect to the fourth surface 34 is, for example, greater than 90 degrees and equal to or less than 120 degrees. When the angle β is equal to or less than 120 degrees, the adjacent second columnar portions 30 can be separated from each other. The angle β may be the same as or different from the angle α. In the example illustrated in the drawing, the second columnar portion 30 has a trapezoidal cross-sectional shape. The second columnar portion 30 has a tapered shape.

The height of the second columnar portion 30 is equal to or greater than 10 nm and equal to or less than 1 μm, preferably equal to or greater than 100 nm and equal to or less than 900 nm, and more preferably equal to or greater than 300 nm and equal to or less than 800 nm. For example, the height of the second columnar portion 30 is greater than the diameter of the second columnar portion 30. The height of the second columnar portion 30 may be the same as or different from the height of the first columnar portion 20.

The diameter of the second columnar portion 30 on the fourth surface 34 is equal to or greater than 10 nm and equal to or less than 1 μm, preferably equal to or greater than 100 nm and equal to or less than 800 nm, and more preferably equal to or greater than 200 nm and equal to or less than 700 nm. The diameter of the second columnar portion 30 may be the same as or different from the diameter of the first columnar portion 20. The diameter of the second columnar portion 30 gradually increases toward the third surface 32 from the fourth surface 34.

The plurality of second columnar portions 30 are provided. The plurality of second columnar portions 30 are separated from each other. In the example illustrated in the drawing, a gap is provided between the adjacent second columnar portions 30. An interval between the adjacent first columnar portions 20 is equal to or greater than 10 nm and equal to or less than 1 μm, preferably equal to or greater than 100 nm and equal to or less than 800 nm, and more preferably equal to or greater than 200 nm and equal to or less than 700 nm. An interval between the adjacent second columnar portions 30 may be the same as or different from the interval between the adjacent first columnar portions 20. The plurality of second columnar portions 30 are arranged at predetermined pitches in a predetermined direction in plan view seen from the direction of the perpendicular P. The plurality of second columnar portions 30 are arranged, for example, in a regular triangular lattice shape or a square lattice shape in plan view seen from the direction of the perpendicular P.

The material of the second columnar portion 30 is, for example, the same as that of the first columnar portion 20. The second columnar portion 30 constitutes a metamaterial. The plurality of second columnar portions 30 constitute a second metasurface 30a. In the example illustrated in the drawing, the second metasurface 30a includes the plurality of second columnar portions 30 and a gap between the adjacent second columnar portions 30. The second metasurface 30a transmits incident light.

Similarly to the first metasurface 20a described above, the second metasurface 30a can modulate the phase of incident light. In the example illustrated in the drawing, the first metasurface 20a and the second metasurface 30a are symmetrical to each other with respect to a virtual plane, not illustrated in the drawing, which is parallel to the first main surface 12. The second columnar portion 30 is formed by, for example, a method similar to that of the first columnar portion 20.

The phase modulation element 110 includes the plurality of second columnar portions 30 that are provided on a side of the substrate 10 opposite to the plurality of first columnar portions 20 and constitute the second metasurface 30a. Each of the plurality of second columnar portions 30 has a third surface 32 which is closest to the substrate 10 and a fourth surface 34 which is farthest from the substrate 10, and the area of the fourth surface 34 is smaller than the area of the third surface 32 in plan view seen from the direction of the perpendicular P.

For this reason, in the phase modulation element 110, light can be modulated by two metasurfaces, that is, the first metasurface 20a and the second metasurface 30a. Thereby, for example, it is possible to reduce the amount of phase modulation of the first metasurface 20a as compared to a case where light is modulated only by the first metasurface 20a. As a result, the height of the first columnar portion 20 can be reduced, and the plurality of first columnar portions 20 can be easily formed. The phase modulation at the metasurfaces 20a and 30a depends on the heights of the columnar portions 20 and 30.

Furthermore, in the phase modulation element 110, the area of the fourth surface 34 is smaller than the area of the third surface 32, and thus it is possible to reduce light reflected by the fourth surface 34 of the second columnar portion 30.

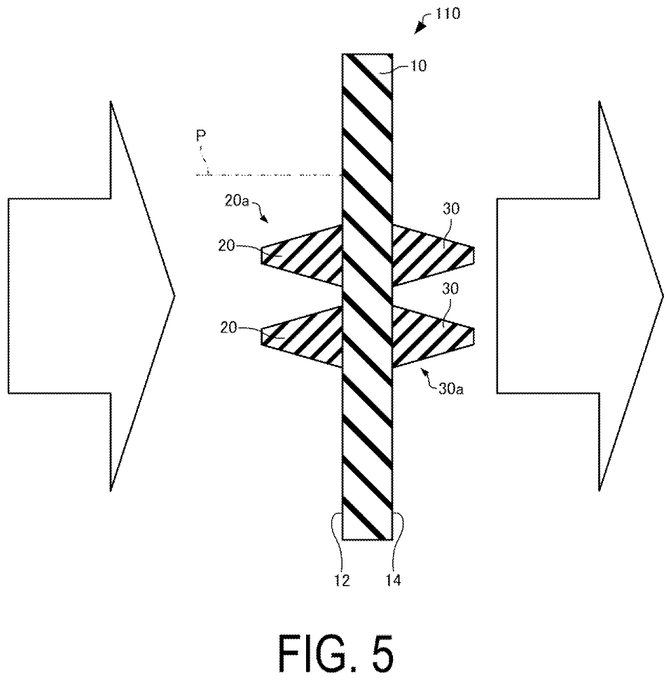

Note that, as illustrated in FIG. 5, the plurality of first columnar portions 20 and the plurality of second columnar portions 30 may be provided only in a predetermined region of the substrate 10. For example, when the dielectric layer 2 is processed by an FIB, the wider a processing area is, the longer a processing time is, and the difficulty of high-definition processing is increased due to the influence of stage drift or the like. When the plurality of first columnar portions 20 and the plurality of second columnar portions 30 are formed only in a predetermined region of the substrate 10, the processing area can be reduced, and the difficulty of processing can be lowered.

### 1.4.2. Second Modification Example

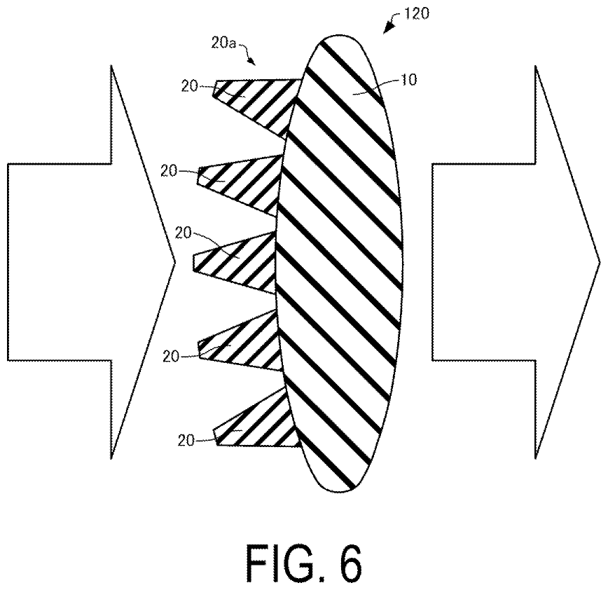

Next, a phase modulation element according to a second modification example of the first embodiment will be described with reference to the drawings. FIG. 6 is a schematic cross-sectional view illustrating a phase modulation element 120 according to the second modification example of the first embodiment.

In the phase modulation element 100 described above, the shape of the substrate 10 is a rectangular parallelepiped as illustrated in FIG. 1.

On the other hand, in the phase modulation element 120, the substrate 10 has a curved surface as illustrated in FIG. 6. The substrate 10 has a function of a lens. The first metasurface 20a has a function of correcting aberration of the substrate 10 as a lens.

In the phase modulation element 120, the substrate 10 has a function of a lens. For this reason, in the phase modulation element 120, it is not necessary to separately provide a lens, and the element can be miniaturized.

### 2. Second Embodiment

### 2.1. Phase Modulation Element

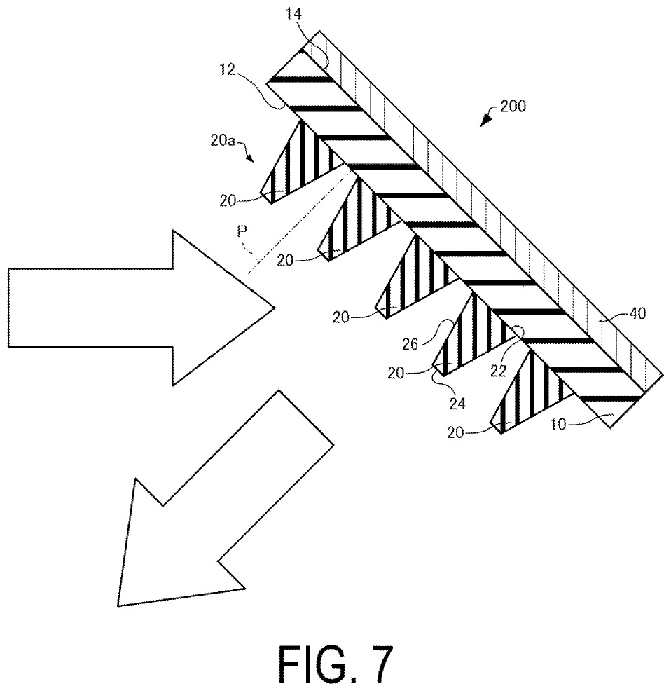

Next, a phase modulation element according to a second embodiment will be described with reference to the drawings. FIG. 7 is a schematic cross-sectional view illustrating a phase modulation element 200 according to the second embodiment.

Hereinafter, in the phase modulation element 200 according to the second embodiment, members having functions similar to those of the constituent members of the phase modulation element 100 according to the first embodiment described above are denoted by the same reference numerals and signs, and detailed description thereof is omitted.

As illustrated in FIG. 7, the phase modulation element 200 is different from the phase modulation element 100 described above in that the phase modulation element 200 includes a reflective portion 40.

The reflective portion 40 is provided on a second main surface 14 of a substrate 10. The reflective portion 40 is, for example, a metal layer made of a metal such as silver or aluminum. The reflective portion 40 reflects light that passed through a first metasurface 20a and the substrate 10. The light reflected by the reflective portion 40 passes through the substrate 10 and the first metasurface 20a and is emitted from a second surface 24 side.

### 2.2. Method of Manufacturing Phase Modulation Element

Next, a method of manufacturing the phase modulation element 200 according to the second embodiment will be described with reference to the drawings.

As illustrated in FIG. 7, the reflective portion 40 is formed at the second main surface 14 of the substrate 10. The reflective portion 40 is formed by, for example, a sputtering method or a vacuum deposition method.

Next, a plurality of first columnar portions 20 are formed at the first main surface 12 of the substrate 10. A method of forming the first columnar portion 20 is basically the same as the method of manufacturing the phase modulation element 100 described above.

The phase modulation element 200 can be manufactured by the above-described process.

### 2.3. Operations and Effects

The phase modulation element 200 includes the reflective portion 40 that reflects light that passed through the first metasurface 20a, and the light reflected by the reflective portion 40 passes through the first metasurface 20a. For this reason, in the phase modulation element 200, light can be modulated twice by the first metasurface 20a, the amount of phase modulation for one time of the metasurface 20a can be reduced. Thereby, it is possible to reduce the height of the first columnar portion 20 and easily form the plurality of first columnar portions 20.

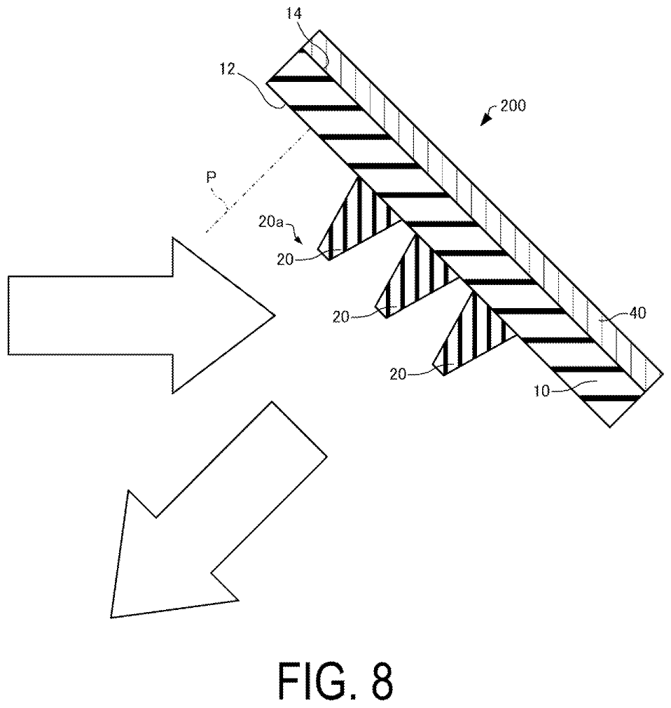

Note that, as illustrated in FIG. 8, the plurality of first columnar portions 20 may be provided only in a predetermined region of the substrate 10.

### 2.4. Modification Example

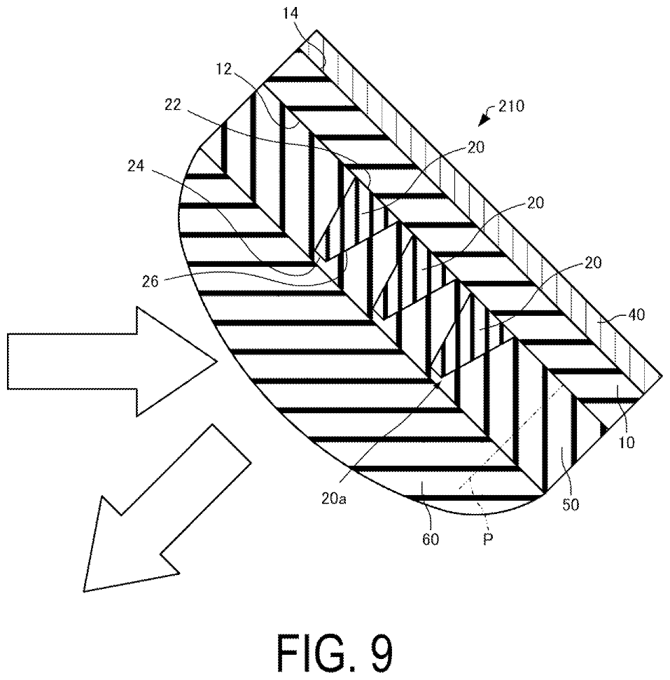

Next, a phase modulation element according to a modification example of the second embodiment will be described with reference to the drawings. FIG. 9 is a schematic cross-sectional view illustrating a phase modulation element 210 according to the modification example of the second embodiment.

Hereinafter, in the phase modulation element 210 according to the modification example of the second embodiment, members having functions similar to those of the constituent members of the phase modulation element 200 according to the second embodiment described above are denoted by the same reference numerals and signs, and detailed description thereof is omitted.

As illustrated in FIG. 9, the phase modulation element 210 is different from the phase modulation element 200 described above in that the phase modulation element 210 includes a low refractive index layer 50 and a lens 60.

The low refractive index layer 50 is provided on the first main surface 12 of the substrate 10. The low refractive index layer 50 is provided between the lens 60 and the substrate 10. The low refractive index layer 50 is provided between the adjacent first columnar portions 20. In the example illustrated in the drawing, the low refractive index layer 50 covers a second surface 24 and a first side surface 26 of the first columnar portion 20.

The refractive index of the low refractive index layer 50 is lower than the refractive index of the first columnar portion 20. The low refractive index layer 50 transmits light. The low refractive index layer 50 is, for example, a silicon oxide layer. The low refractive index layer 50 is formed by, for example, a CVD method or a spin coating method.

The lens 60 is provided in the low refractive index layer 50. Light that passed through the first metasurface 20a is incident on the lens 60. The light is incident on the phase modulation element 210 from the lens 60, passes through the first metasurface 20a, is reflected by the reflective portion 40, passes through the first metasurface 20a again, and is emitted from the lens 60.

The material of the lens 60 is, for example, glass. The lens 60 is, for example, a refractive lens. Note that the type of the lens 60 is not particularly limited, and may be a concave lens or an off-axis lens. For example, the first metasurface 20a has a function of correcting aberration of the lens 60.

The phase modulation element 210 includes the lens 60 on which light that passed through the first metasurface 20a is incident. For this reason, in the phase modulation element 210, the phase of incident light can be modulated by the first metasurface 20a and the lens 60.

For example, metasurfaces having a large-sized area are expensive to manufacture. For this reason, a function that can be performed by the lens 60 is performed by the lens 60, and the first metasurface 20a is formed with a minimum area to reinforce the function of the lens 60, whereby cost reduction can be achieved.

Further, for example, when the lens 60 is a refractive lens, the lens efficiency of the first metasurface 20a as a refractive lens is lower than that of the lens 60. For this reason, by combining the lens 60 and the first metasurface 20a, a function that cannot be performed by the lens 60 can be added to the first metasurface 20a while suppressing a decrease in lens efficiency. For example, in the first metasurface 20a, the lens efficiency decreases as a numerical aperture (NA) increases, and thus it is preferable to use the lens 60 for a function that can be performed by the lens 60. Note that the “lens efficiency as a refractive lens” means a ratio of light condensed at a focal point.

### 3. Third Embodiment

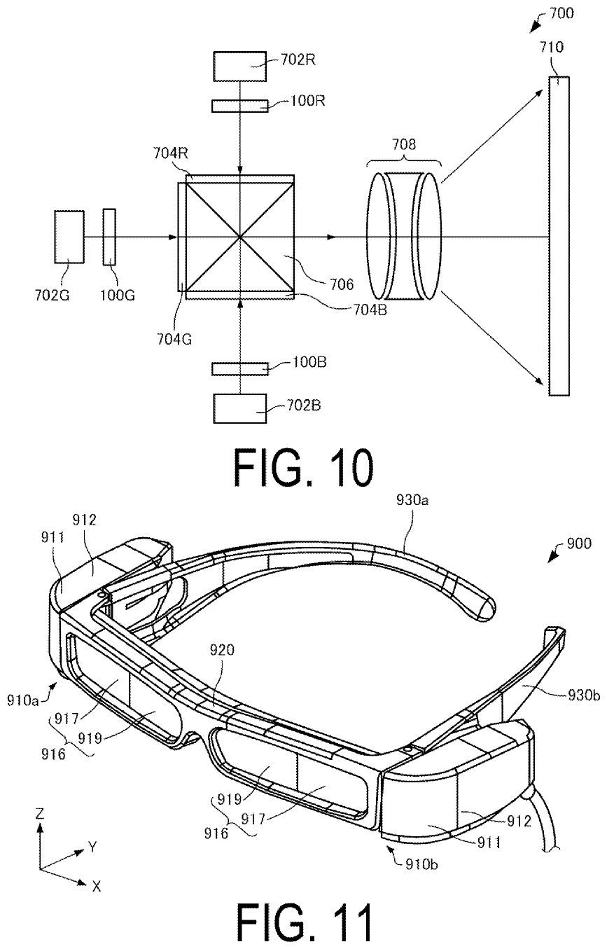

Next, a projector according to a third embodiment will be described with reference to the drawings. FIG. 10 is a schematic diagram illustrating a projector 700 according to the third embodiment.

The projector 700 includes a housing which is not illustrated in the drawing, and a red light source 702R, a green light source 702G, and a blue light source 702B that are provided in the housing and emit red, green, and blue light, respectively, as illustrated in FIG. 10. Each of the light sources 702R, 702G, and 702B is constituted by, for example, a semiconductor laser and a light emitting diode (LED).

The projector 700 further includes a phase modulation element 100 as an optical element.

The projector 700 includes a first optical element 100R, a second optical element 100G, a third optical element 100B, a first light modulation device 704R, a second light modulation device 704G, a third light modulation device 704B, and a projection device 708, which are provided in the housing. The first light modulation device 704R, the second light modulation device 704G, and the third light modulation device 704B are, for example, transmissive liquid crystal light valves. The projection device 708 is, for example, a projection lens. The projection lens may be constituted by the phase modulation element 100.

Light emitted from the red light source 702R is incident on the first optical element 100R. Light emitted from the red light source 702R is condensed by the first optical element 100R. Note that the first optical element 100R may have a function other than light condensing. The same applies to the second optical element 100G and the third optical element 100B to be described later.

Light condensed by the first optical element 100R is incident on the first light modulation device 704R. The first light modulation device 704R modulates incident light in accordance with image information. Then, the projection device 708 enlarges an image formed by the first light modulation device 704R and projects the enlarged image on a screen 710.

Light emitted from the green light source 702G is incident on the second optical element 100G. The light emitted from the green light source 702G is condensed by the second optical element 100G.

The light condensed by the second optical element 100G is incident on the second light modulation device 704G. The second light modulation device 704G modulates the incident light in accordance with image information. Then, the projection device 708 enlarges an image formed by the second light modulation device 704G and projects the enlarged image onto the screen 710.

Light emitted from the blue light sources 702B is incident on the third optical element 100B. The light emitted from the blue light sources 702B is condensed by the third optical element 100B.

The light condensed by the third optical element 100B is incident on the third light modulation device 704B. The third light modulation device 704B modulates the incident light in accordance with image information. Then, the projection device 708 enlarges an image formed by the third light modulation device 704B and projects the enlarged image onto the screen 710.

The projector 700 further includes a cross dichroic prism 706 that combines light beams emitted from the first light modulation device 704R, the second light modulation device 704G, and the third light modulation device 704B and guides the combined light beam to the projection device 708.

The three color light beams modulated by the first light modulation device 704R, the second light modulation device 704G, and the third light modulation device 704B are incident on the cross dichroic prism 706. The cross dichroic prism 706 is formed by bonding four right-angle prisms together, and a dielectric multilayer film configured to reflect red light and a dielectric multilayer film configured to reflect blue light are disposed on the inner surface of the cross dichroic prism 706. The three types of color light are combined by these dielectric multilayer films, and light representing a color image is formed. Then, the combined light is projected onto the screen 710 by the projection device 708, and an enlarged image is displayed.

Note that, by controlling the red light source 702R, the green light source 702G, and the blue light source 702B as pixels of an image in accordance with image information, the image may be directly formed without using the first light modulation device 704R, the second light modulation device 704G, and the third light modulation device 704B. In addition, the projection device 708 may enlarge the image formed by the red light source 702R, the green light source 702G, and the blue light source 702B and project the enlarged image onto the screen 710.

Although the transmissive liquid crystal light valve is used as the light modulation device in the above-described example, a light valve other than the liquid crystal light valve may be used, or a reflective light valve may be used. Examples of such a light valve include a reflective liquid crystal light valve, a digital micro mirror device, and the like. In addition, the configuration of the projection device is appropriately changed depending on the type of light valve to be used.

Further, the light source can also be applied to a light source device of a scanning type image display device including a scanning unit which is an image forming device for displaying an image having a desired size on a display surface by scanning the screen with light from the light source.

In addition, light combined by the cross dichroic prism may be emitted not to the screen but to, for example, a whiteboard, a wall, or the like by the projection device. In this case, the projector may have a function of sensing the shape of an irradiated region by infrared rays or the like.

### 4. Fourth Embodiment

### 4.1. Overall Configuration

Next, a head-mounted display according to a fourth embodiment will be described with reference to the drawings. FIG. 11 is a schematic perspective view illustrating a head-mounted display 900 according to the fourth embodiment. Note that an x-axis, a y-axis, and a z-axis are illustrated in FIG. 11 as three axes orthogonal to each other.

As illustrated in FIG. 11, the head-mounted display 900 is a head-mounted type display device having an appearance like spectacles. The head-mounted display 900 is worn on an observer's head. The observer is a user who uses the head-mounted display 900. The head-mounted display 900 allows the observer to be able to visually recognize video light by a virtual image and visually recognize an external image in a see-through manner. The head-mounted display 900 can also be referred to as a virtual image display device.

The head-mounted display 900 includes, for example, a first display unit 910a, a second display unit 910b, a frame 920, a first temple 930a, and a second temple 930b.

The first display unit 910a and the second display unit 910b display an image. Specifically, the first display unit 910a displays a virtual image for the right eye of the observer. The second display unit 910b displays a virtual image for the left eye of the observer. In the example illustrated in the drawing, the first display unit 910a is provided in the −X-axis direction of the second display unit 910b. The display units 910a and 910b include, for example, an image forming device 911 and a light guiding device 916.

The image forming device 911 forms image light. The image forming device 911 includes, for example, an optical system such as a light source and a projection device, and an external member 912. The external member 912 accommodates the light source, the projection device, and the like.

The light guiding device 916 covers the front of the eyes of the observer. The light guiding device 916 guides video light formed by the image forming device 911 and allows the observer to visually recognize external light and the video light in an overlapping manner. Note that details of the image forming device 911 and the light guiding device 916 will be described later.

The frame 920 supports the first display unit 910a and the second display unit 910b. For example, the frame 920 surrounds the display units 910a and 910b when viewed from the Y-axis direction. In the example illustrated in the drawing, the image forming device 911 of the first display unit 910a is attached to an end portion of the frame 920 in the −X-axis direction. The image forming device 911 of the second display unit 910b is attached to an end portion of the frame 920 in the +X-axis direction.

The first temple 930a and the second temple 930b extend from the frame 920. In the example illustrated in the drawing, the first temple 930a extends in the +Y-axis direction from an end portion of the frame 920 in the −X-axis direction. The second temple 930b extends in the +Y-axis direction from an end portion of the frame 920 in the +X-axis direction.

The first temple 930a and the second temple 930b are suspended on the ears of the observer when the head-mounted display 900 is worn on the observer. The head of the observer is positioned between the temples 930a and 930b.

### 4.2. Image Forming Device and Light Guiding Device

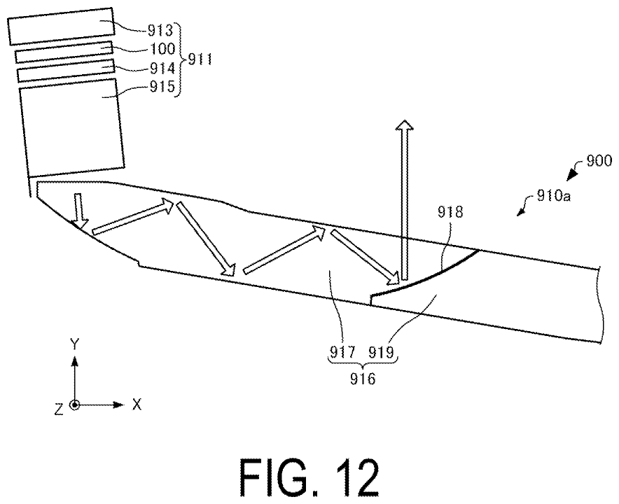

FIG. 12 is a schematic diagram illustrating the image forming device 911 and the light guiding device 916 of the first display unit 910a of the head-mounted display 900 according to the fourth embodiment. Note that the first display unit 910a and the second display unit 910b basically have the same configuration. Thus, the following description of the first display unit 910a can be applied to the second display unit 910b.

As illustrated in FIG. 12, the image forming device 911 includes, for example, a phase modulation element 100, a light source 913, a light modulation device 914, and a projection device 915 for image formation.

The light source 913 emits light. The light source 913 is constituted by, for example, a semiconductor laser or an LED. Light emitted from the light source 913 is incident on the phase modulation element 100. The light emitted from the light source 913 is condensed by the phase modulation element 100. Note that the phase modulation element 100 may have a function other than the light condensing function.

The light modulation device 914 modulates light condensed by the phase modulation element 100 in accordance with image information and emits video light. The light modulation device 914 is a transmissive liquid crystal light valve. Note that the light source 913 may be a self-luminous light source that emits light in accordance with input image information. In this case, the light modulation device 914 is not provided.

The projection device 915 projects the video light emitted from the light modulation device 914 toward the light guiding device 916. The projection device 915 is, for example, a projection lens. The projection lens may be constituted by the phase modulation element 100. As the lens constituting the projection device 915, a lens having an axially symmetric surface as a lens surface may be used.

For example, the light guiding device 916 is accurately positioned with respect to the projection device 915 by being screwed to a lens barrel of the projection device 915. The light guiding device 916 includes, for example, a video light guiding member 917 that guides video light and a see-through member 919 for see-through.

Video light emitted from the projection device 915 is incident on the video light guiding member 917. The video light guiding member 917 is a prism that guides video light toward the eyes of the observer. The video light incident on the video light guiding member 917 is repeatedly reflected from the inner surface of the video light guiding member 917, is reflected by a reflective layer 918, and is emitted from the video light guiding member 917. The video light emitted from the video light guiding member 917 reaches the eyes of the observer. In the example illustrated in the drawing, the reflective layer 918 reflects the video light in the +Y-axis direction. The reflective layer 918 is constituted by, for example, a metal or a dielectric multilayer film. The reflective layer 918 may be a half mirror.

The see-through member 919 is adjacent to the video light guiding member 917. The see-through member 919 is fixed to the video light guiding member 917. For example, the outer surface of the see-through member 919 is continuous with the outer surface of the video light guiding member 917. The see-through member 919 allows the observer to see through external light. Note that the video light guiding member 917 also has a function of allowing an observer to see through external light in addition to the function of guiding video light.

The phase modulation element according to the above-described embodiment can also be used for applications other than the projector and the head-mounted display. The phase modulation element according to the above-described embodiment can be used in, for example, a camera, a scanner, spectacles, an intraocular lens, and a contact lens.

The above-described embodiments and modification examples are merely examples, and the present disclosure is not limited thereto. For example, the embodiments and the modification examples can also be combined as appropriate.

The present disclosure includes substantially the same configuration as the configuration described in the embodiment, for example, a configuration having the same function, method, and results or a configuration having the same object and effects. In addition, the present disclosure includes a configuration in which non-essential portions in the configurations described in the embodiments are replaced. In addition, the present disclosure includes a configuration that exhibits the same operations and effects or a configuration that can achieve the same object as the configurations described in the embodiments. In addition, the present disclosure includes a configuration in which a known technique is added to the configuration described in the embodiment.

The following content is derived from the above-described embodiments and modification examples.

An aspect of a phase modulation element includes a substrate and a plurality of first columnar portions constituting a first metasurface, in which each of the plurality of first columnar portions includes a first surface that is closest to the substrate, and a second surface that is farthest from the substrate, and an area of the second surface is smaller than an area of the first surface in plan view from a direction perpendicular to the substrate.

According to the phase modulation element, it is possible to reduce light reflected by the second surface of the first columnar portion.

In the aspect of the phase modulation element, a diameter of each of the plurality of first columnar portions may gradually increase toward the first surface from the second surface.

According to the phase modulation element, it is possible to reduce light reflected by the side surface connecting the first surface and the second surface of the first columnar portion.

In the aspect of the phase modulation element, a refractive index of the substrate may be lower than a refractive index of each of the plurality of first columnar portions.

According to the phase modulation element, an optical confinement factor of the first metasurface can be increased.

In the aspect of the phase modulation element, the phase modulation element may further include a plurality of second columnar portions provided on a side of the substrate opposite to the plurality of first columnar portions and constituting a second metasurface, in which each of the plurality of second columnar portions may include a third surface that is closest to the substrate, and a fourth surface that is farthest from the substrate, and an area of the fourth surface may be smaller than an area of the third surface in plan view seen from the direction perpendicular to the substrate.

According to the phase modulation element, the height of the first columnar portion can be reduced.

In the aspect of the phase modulation element, the phase modulation element may further include a reflective portion reflecting light that passed through the first metasurface, in which the light reflected by the reflective portion may pass through the first metasurface.

According to the phase modulation element, the height of the first columnar portion can be reduced.

In the aspect of the phase modulation element, the phase modulation element may further include a lens on which the light that passed through the first metasurface is incident.

According to the phase modulation element, the phase of the incident light can be modulated by the first metasurface and the lens.

An aspect of a projector includes an aspect of the phase modulation element.

An aspect of a head-mounted display includes an aspect of the phase modulation element.

What is claimed is:

1. A phase modulation element comprising:
a substrate; and
a plurality of first columnar portions constituting a first metasurface, wherein
each of the plurality of first columnar portions includes a first surface that is closest to the substrate, and a second surface that is farthest from the substrate, and
an area of the second surface is smaller than an area of the first surface in plan view from a direction perpendicular to the substrate.

2. The phase modulation element according to claim 1, wherein a diameter of each of the plurality of first columnar portions gradually increases toward the first surface from the second surface.

3. The phase modulation element according to claim 1, wherein a refractive index of the substrate is lower than a refractive index of each of the plurality of first columnar portions.

4. The phase modulation element according to claim 3, further comprising:
a plurality of second columnar portions provided on a side of the substrate opposite to the plurality of first columnar portions and constituting a second metasurface, wherein
each of the plurality of second columnar portions includes a third surface that is closest to the substrate, and a fourth surface that is farthest from the substrate, and
an area of the fourth surface is smaller than an area of the third surface in plan view seen from the direction perpendicular to the substrate.

5. The phase modulation element according to claim 1, further comprising:
a reflective portion reflecting light that passed through the first metasurface, wherein
the light reflected by the reflective portion passes through the first metasurface.

6. The phase modulation element according to claim 1, further comprising:
a lens on which the light that passed through the first metasurface is incident.

7. A projector comprising the phase modulation element according to claim 1.

8. A head-mounted display comprising the phase modulation element according to claim 1.
